(19) United States
(12) Patent Application Publication
(10) Pub. No.: US 2015/0079578 A1
(43) Pub. Date: Mar. 19, 2015

(54) NEUROLOGICAL PERFORMANCE QUOTIENT

(71) Applicant: Dario Nardi, West Hollywood, CA (US)

(72) Inventor: Dario Nardi, West Hollywood, CA (US)

(73) Assignee: Dario Nardi, West Hollywood, CA (US)

(21) Appl. No.: 13/964,052

(22) Filed: Aug. 10, 2013

(51) Int. Cl. G09B 7/06

(52) U.S. Cl. CPC G09B 7/06
USPC 434/362

(57) ABSTRACT

This Invention is a psychometric instrument that generates scores for highly specific neurological skills. UNDERLYING RESEARCH: Brain-mapping data is generated by EEG testing on multiple human subjects while performing tasks related to specific brain regions. Scores are calculated, algorithms developed, and visual diagrams drawn. The data is compared to known functions for specific brain neocortex regions, and verified by independent testing for psychological types by statistical analysis. PSYCHOMETRIC INSTRUMENT: Patterns in the brain-mapping data are identified and sorted into neurological skill sets. Questions for specific neurological skills are developed from the data, and a scoring system devised. The instrument is administered to clients who answer specific graded questions. SKILLS PROFILE: The instrument compiles and reports on multiple neurological skill sets, including: 20 cognitive skills, right/left hemispheric balance, five sensory modalities (auditory, kinesthetic, visual, meta, executive), and four competency skill sets (directive, analytical, expressive, reflective). Applications include: counseling, business and education.

### CROSS-REFERENCE TO RELATED APPLICATIONS

This application claims priority to the Provisional Patent Application No. 61/682,242, filed Aug. 10, 2012.

### BACKGROUND OF THE INVENTION

1. Field of Invention

The invention is a novel psychometric instrument, derived from brain-mapping, that generates scores for highly specific neurological skills sets for individuals.

2. Prior Art

There are multiple problems with previous psychological evaluation systems. In general, most psychometric instruments assume a normal (typical) population and are self-assessments rather than actual skills tests. Whereas most actual tests typically focus on reasoning and memory, but do not assess social or physical skills. Many instruments test for traits; but traits are not skills. Finally, the problem with most psychological evaluation systems is that they are based on indirect evidence of cognitive or personality patterns—not on neuroscience. Some involve psychometric instruments (scorable questionnaires), sortable card systems, or computer programs. Other researchers (Alcock, Gram, and Laposky) have attempted correlations between EEG and psychological types. But each failed to find meaningful results, beyond minor isolated correlations, likely because they engaged in short experimental sessions and used the wrong parameters. Still others used brain mapping to evaluate a person's mental state when responding to a traditional psychometric instrument. However, none were able to find system-wide correlations for either psychological evaluation, psychological types/traits, or skills assessment, or to develop any other definitive systems. Hence, no other inventor has successfully formulated a psychometric instrument to assess neurological skills based on brain mapping.

### PRIOR PATENTS

A patent search shows seven (7) methods or systems as patents or pending patent applications. These include:
Shovers, Aaron: “Personality Analyzer”, U.S. Pat. No. 5,696,981, Dec. 9, 1997.
Bryce, Nathan & Kesterson, Russell: “Personality Testing Apparatus and Method, U.S. Pat. No. 5,702,253, Dec. 30, 1997.
Hewson, Roger, Raymond, M. E. “Developing The Twelve Cognitive Functions of Individuals”, Patent Application No. 2005/0181339 A1, Aug. 18, 2005.
Tan, Ah Thau: “Psychometric Assessment Tool and Method for Interpreting Human Personality and Human Behavior.” Patent No. 2007/0048706 A1, Mar. 1, 2007.
Chan, John Lap Man: “System and Device for Determining Personality Type,” U.S. Pat. No. 7,950,664 B2. May 31, 2011.
Jung, Leuthardt, Levien, Lord, Malamud, Rinaldo, and Wood: “Methods and Systems for Indicating Behavior in a Population Cohort”, Patent Application No. 2009/0164403 A1, Jun. 25, 2009.
Molina, Bruekers, Damstra, and Weda: “Relating to Brain Computer Interfaces”, Patent Application No. 2011/0238585 A1, Sep. 29, 2011.

### Prior Assessment Systems for Neurological or Cognitive Skills

A search of the literature shows multiple cognitive assessment systems, as books, articles, or psychometric instruments (scorable questionnaires). Most of these are personality typing systems; none are for neurological skills sets based on brain-mapping. These include:
Four (4) Quadrant Cognitive Types: C. Victor Bunderson, Dissertation: The Validity of the Herrmann Brain Dominance Instrument, published by Herrmann International, 1985
Four (4) DiSC Social Styles: Marston, William M. (1928). Emotions of Normal People. Cooper Press, Reprint 2007.
Five (5) Personality Factors: Costa, P. T., Jr. & McCrae, R. R. Revised NEO Personality Inventory (NEO-PI-R) and NEO Five-Factor Inventory (NEO-FFI) manual. Odessa, Fla.: Psychological Assessment Resources, 1992.
Five (5) Sensory Modalities: Accepted as basic neuro-physiology.
Eight (8) Multiple Intelligences: Gardner, Howard. Frames of Mind: The Theory of Multiple Intelligences. Basic Books, 1993.
Eight (8) Jungian Mental Functions: Jung, Carl. Psychological Types. Reprint, Princeton, N.J.: Princeton University Press, 1960.
Myers & Briggs: (16 types) MBTI (Myers-Briggs Type Indicator Instrument®) Isabel Briggs Myers, Mary H. McCaulley, Naomi L. Quenk, Allen L. Hammer. MBTI Manual: A guide to the development and use of the Myers Briggs type indicator (3rd ed). Consulting Psychologists Press, 1998
Twenty (20) Cognitive Abilities: Woodcock, Richard R.; Fredrick A. Schenk, et. al. Essentials of WJ III Cognitive Abilities Assessment. Wiley, 2010.

### Prior Related Brain Research

To create a comprehensive brain-based questionnaire for cognition or personality, a wide range of published research in books and articles were reviewed. Here is a sample.
Colin G DeYoung, Jacob B Hirsh, Matthew S Shane, Xenophon Papademetris, Nallakkandi Rajeevan, and Jeremy R Gray. “Testing Predictions From Personality Neuroscience: Brain Structure and the Big Five”. Psychological Science, 21(6) (pages 820-828), 2010.
D Erik Everhart, David W. Harrison. “Hostility Following Right CVA: Support for Right Orbital Frontal Deactivation and Right Temporal Activation”. ISNR.
Ginette C Blackhart, John P Kline. “Individual differences in anterior EEG asymmetry between high and low defensive individuals during a rumination/distraction task”. Personality and Individual Differences, 39 (pages 427-437), 2005.
J M Kilner, J L Marchant, and C D Frith. “Modulation of the mirror system by social relevance”. Social Cognitive and Affective Neuroscience, Vol. 1 (pp 143-148), 2006.
Marvin Zuckerman. Psychobiology of Personality, 2nd edition. Cambridge University Press, April 2005.
Norbert Jausovec. “Differences in Cognitive Processes Between Gifted, Intelligent, Creative and Average Individuals While Solving Complex Problems: An EEG Study”. Elsevier Science, 2000. (Available online: www.sciencedirect.com).
Peter C Gram, Bruce R Dunn, and Diana Ellis. “Relationship Between EEG and Psychological Type”. Journal of Psychological Type, Issue 5, November 2005.
Tetsuto Minami, K Goto, M Kitazaki, and S Nakauchi. “Asymmetry of P3 amplitude during oddball tasks reflects the unnaturalness of visual stimuli”. NeuroReport, Vol. 20 (pages 1471-1476), 2009.

### The Author's Prior Art (Chronological Order)

(1) Nardi, Dario: ISCA (Interstrength Cognitive Assessment™) is a psychometric instrument. The white paper describing it was published as Nardi, Dario: The Interstrength Cognitive Assessment: Development of a validated cognitive development psychometric (Research report 2), online in 2006. The ISCA is the psychometric assessment that Nardi developed to profile the eight mental types as defined by Carl Jung (1875-1961). Jung described mental functions (cognitive processes) based on his qualitative observations and conjecture. The ISCA reports percentage uses of specific cognitive processes, according to Jung's theories, based on Nardi's questionnaire. The ISCA does NOT include: (1) methods based on brain-mapping or MBTI; or (2) results describing detailed type profiles; or (3) results describing neurological skills profiles. The ISCA does NOT include Nardi's subsequent original research, and is not included in his provisional patent application or either non-provisional patent application related thereto.
(2) The current Invention, incorporated herein, the Neurological Performance Quotient™ (or Neuro-PQ), was first published online on Jan. 19, 2012. It was incorporated into Dario Nardi's Provisional Patent Application No. 61/682,242 titled Nardi Neurotype System & Neurological Performance Quotient, filed Aug. 10, 2012. This invention is a psychometric instrument, based on brain mapping and its known functions, that generates an assessment of a person's neurological skills. The NeuroPQ is objective and substantially different in subject matter from Nardi's other Inventions, (1) the ISCA and (3) Neurological Type Profile System.
(3) A related but separate Invention, Nardi's Neurological Type Profile System (or Neuro-Type Profiler) is a psychological typing system by author Dario Nardi, consisting of eight types. It was first published in his related book: “Neuroscience of Personality,” Radiance House, Los Angeles, copyright July 2011, released Aug. 12, 2011. It was released and introduced to professionals at the APTi Biennial Conference (Association of Psychological Type International) on Aug. 12, 2011, on the same day that he was the keynote speaker there. It also was incorporated into Dario Nardi's Provisional Patent Application No. 61/682,242 titled Nardi Neurotype System & Neurological Performance Quotient, filed Aug. 10, 2012. It is being submitted as a separate Patent Application from the Neuro-PQ. This Invention, the NeuroType Profiler, is a psychometric instrument, an assessment process using EEG brain-mapping, with verification from the scientific literature and a psychometric instrument, such as the ICSA (Nardi) or the MBTI personality type instrument, to assess a person's dominant cognitive type (one of eight). It reports brain-mapping details in percentages, as dominant brain-mapping traits, and as detailed textual profiles, consisting of cognitive and personality and physical traits. While it shares many brain-mapping methods with the Neurological Performance Quotient, the topics and results are substantially different. The Neuro-Type Profiler is objective and substantially different in methods of development, presentation of results, and psychological profiles from the ISCA.

### SUMMARY OF THE INVENTION

This Invention, Neurological Performance Quotient™ (or NeuroPQ), is a novel psychometric instrument that generates scores for highly specific neurological skill sets. The Invention is based on brain mapping, the known functions of mapped regions in the brain neocortex, and independent testing for cognitive type. This kind of direct neurological assessment for skills, and the psychometric instrument derived from it, is a new invention. METHODS: The skills profile may be generated directly from brain-mapping and novel algorithms, or it may be generated by the Neuro-PQ psychometric instrument derived from brain-mapping. The brain-mapping data is generated by an EEG machine or comparable device, data analyzed, algorithms developed, and visual diagrams and numeric scores developed to convey patterns. The NeuroPQ instrument is generated from questions based on brain-mapping patterns and known functions of brain neocortex regions, and verified by independent testing for cognitive type. RESULTS: The instrument is administered to clients who self-report. Based on their answers to highly specific and graded questions, the instrument generates results in percentages (and optionally colors or shades) for each factor assessed. The instrument compiles and reports multiple neurological skill sets, including factors for: cognition (16-20), two values for hemispheric balance, use of five or more sensory modalities (auditory, kinesthetic, visual, meta, and executive), and four or more skill sets (directive skills, analytical skills, expressive skills, and reflective skills). CONCLUSIONS: The Invention is a useful, novel, and unobvious process that accurately assesses neurological skills. Commercial applications include: clinical counseling, business, and education.

### DRAWINGS

FIG. 1, “Nardi-brain-map.pdf”, is an illustration of a birdseye view of the brain, portioned into 16 to 20 assessable sections, showing neocortex activity on a human individual. Each section has specific neurological functions identified in published scientific papers. In the Invention this map is used for methodology, the Questionnaire, and reporting results.

### OBJECTS & ADVANTAGES

The object of the invention is to provide a psychometric instrument for assessing multiple neurological and cognitive skills. The advantages include:

1.) The Invention is more accurate because it employs objective brain mapping as its basis.
2.) The functions of each brain region are based on published scientific research.
3.) The Invention is verified by highly vetted psychometric instruments (ISCA or MBTI).
4.) The Invention identifies multiple neurological skills by means not previously available.
5.) The Invention measures and ranks sixteen to twenty innate cognitive skills.
6.) The Invention measures and ranks hemispheric balance (right brain vs left brain).
7.) The Invention measures and ranks five sensory modalities.
8.) The Invention measures and ranks four skill sets (directive/protective skills, technical/logical skills, expressive/social skills, and reflective/artistic skills).
9.) The NeuroPQ instrument is faster, cheaper, and easier to administer than brain mapping.
10.) The NeuroPQ instrument can be administered to millions of people in multiple formats, including: online, as a computer program, a written questionnaire, by card sorting, or orally.

### DETAILED DESCRIPTION OF THE INVENTION

### Preferred Embodiments

The most preferred embodiment is the following:

### 1. Neurological Performance Quotient™

A method of formulating a novel psychometric instrument (scorable questionnaire), based on data from brain mapping for the purpose of generating a neurological skills profile for an individual, comprising the following steps:
(a) Conducting brain wave mapping on human subjects to identify the levels of intensity of specific brain wave patterns in and across regions with known functions, while administering tasks related to specific brain regions;
(b) Researching and developing a table of neurological functions for specific regions of the brain neocortex, and linking said functions with the brain mapping data from step (a).
(c) Assessing cognitive skill levels and/or psychological traits/types of each subject;
(d) Verifying the brain mapping data (step a) and related functions (step b) with a psychometric assessment from step (c), using appropriate statistical methods to develop and/or verify data;
(e) Identifying patterns in the data (step d) to group data into different neurological skill sets;
(f) Developing questions for specific neurological skills, based on the data (step d), for the purpose of formulating a psychometric instrument for neurological skills;
(g) Devising a report containing an evaluation and scoring system for the instrument;
(h) Optionally, administering the instrument to subjects tested in step (a) and step (c) to validate and refine questionnaire accuracy;
(i) Administering the refined instrument to a future individual to generate a neurological skills profile.

### 2. Brain-Mapping Method

In the preferred method brain wave mapping is conducted by electro-encephalographic (EEG) brain wave mapping on human subjects, or a comparable device, wearing a wired cap connected to a stationary monitor, for measuring and recording the electrical intensity of specific neocortical regions, each having a designated code and known function, and identifying specific brain wave patterns, which manifest in or across specific neocortical regions, in response to a variety of questions and stimuli administered by a researcher or psychotherapist, over a two to three hour period. The minimum number of subjects preferred is 40; whereas 80 subjects is still more preferred.

### 3. Brain-Mapping Alternate Method

In the alternate method brain wave mapping is conducted on a subject who is fitted with a wireless EEG headset that connects to a wearable or stationary monitor, for measuring and recording electrical intensity of specific neocortical regions, each having a designated code and known function, and wherein brain wave patterns, which manifest in or across specific neocortical regions, are generated in response to ordinary daily activity that is recorded in an activity log, and is periodically monitored by a researcher or psychotherapist.

### 4. Define Functions of Neocortex Regions

The preferred method of researching and developing a table of neurological functions or skills for specific regions (or set of regions) of the brain neocortex, and linking said functions with the brain wave mapping data; and wherein each region is designated by a code name, a skill set, and a brief profile defining psychological and neurological functions, as shown in Table 1.

TABLE 1
Twenty Neocortex Regions and Their known Functions *

| REGION | SKILL SET | PROFILE |
|---|---|---|
| Fp1 | Chief Judge | Decide between options. Filter out distractions to stay positive. |
| | (Fp1-ext.) | Focus on achieving a goal. Organize with confidence. |
| | Proof Polisher | Detect an error. Provide a reason. Correct something to be self- |
| | (Fp1-int.) | consistent. Limit range of facial expressions. |
| Fp2 | Authentic | Seek new ideas or stimulation. Facilitate a group in an emergent |
| | Enthusiast | way. Show facial expressions that honestly convey emotions. |
| | (Fp2-ext.) | |
| | Process | Track your step in a process. Perceive you are done |
| | Manager | brainstorming. Apply to yourself new or unpleasant ideas. |
| | (Fp2-int.) | |
| F7 | Imaginative | Infer based on context/analogy. Imagine a place or time. Mirror |
| | Mimic | other's behavior. Ask “what-if.” Mentally play out situation. |
| F8 | Grounded | Recall exact details. Speak a word with emphasis. Identify |
| | Believer | beliefs. Rate how much you like or dislike. Ignore context. |
| F3 | Deductive | Make logical deductions. Backtrack reasoning to correct an |
| | Analyst | error. Follow a chain of reasoning. Devise action steps. |
| F4 | Witty | Sense how well something fits a category. Link two concepts |
| | Classifier | together. Interpret or compose metaphors. “Get” abstract joke. |
| T3 | Precise | Compose complex sentences. Form proper words, grammar, and |
| | Speaker | usage. Analyzing content of speech. Manage sexual impulses. |
| T4 | Intuitive | Attend to tone of voice, when it resonates, seems phony, or has |
| | Listener | powerful affect. Recall melodies. Manage your hostile impulses. |
| C3 | Factual | Remember facts. Retrieve information and sequences. Draw |
| | Storekeeper | skillful charts, tables, and diagrams. Move or feel right side. |
| C4 | Flowing | Retrieve memories of beautiful things or places. Draw skillful |
| | Artist | realistic free-hand drawings. Move or feel whole body. |
| T5 | Sensitive | Sensitive to and curious of other's opinions of you. Analyze |
| | Mediator | faces. Adjust your behavior to appease. Feel embarrassed. |
| T6 | Purposeful | Notice abstract spatial relationships. Assign symbolic meanings. |
| | Futurist | Envision/predict future events. Recognize faces. |
| P3 | Tactical | Integrate vision with action. Physical sense of self, boundaries, |
| | Navigator | and objects. Navigate precisely thru space. Detect shadowy |
| | (P3-anterior) | threats. |
| | Number | Read quickly. Skillful arithmatic performance and rote memory. |
| | Cruncher | Use finger or pointer to focus. Notice odd-ball objects. |
| | (P3-posterior) | |
| P4 | Body Balancer | Notice inner body sensations (hunger, etc). Sympathize (e.g. feel |
| | (P4-anterior) | another's pain). Maintain spacial orientation. Dress and groom. |
| | Strategic Gamer | Juggle multiple variables. Weigh pros and cons, risks vs |
| | (P4-posterior) | rewards. Link distrantly related data. Identify and apply leverage |
| | | (influence). |
| O1 | Visual | Understand 3D visuals. Trust visual data as aid to think. See |
| | Engineer | precisely how to disassemble, rotate, and reassemble objects. |
| O2 | Abstract | Evaluate visual aesthetic design of colors, shapes, styles, themes, |
| | Impressionist | etc. Notice body language to detect people's character. |

* References: See Prior Art: Related Brain Research.

### 5. Psychometric Assessment

A psychometric instrument (scorable questionnaire) may be selected from the group consisting of: (a) the ISCA (Interstrength Cognitive Assessmen™ by Dario Nardi), that determines eight cognitive types and profiles and/or Myers-Briggs 4-letter codes (16 types); (b) the MBTI (Myers-Briggs Type Indicator Instrument®) that determines sixteen personality types and profiles; (c) the MPTI (Majors Personality Type Indicator™) that determines sixteen personality types and profiles, and/or (d) any equivalent psychometric instrument.

### 6. Analyzing Data: Statistical Methods

Preferred statistical methods include the two commonly accepted methods for EEG research: (a) qualitative analysis, consisting of observations recorded in a lab book and/or on video, of recorded brain wave activity and behavior patterns; and (b) quantitative analysis, consisting of original algorithms and factor analysis based on recorded EEG session data. Factors for analysis include the anatomical brain region codes (16 or more codes). Factors for verification may include: relevant published scientific research, the eight cognitive function designations (ISCA, Nardi, most preferred), the sixteen personality designations (MBTI or MPTI), or any other equivalent psychometric instrument. Optionally, data may be analyzed to determine sub-regions of brain activity based on: (1) linkages between two or more brain regions; (2) regions that often activate simultaneously; (3) a nullifying effect; and/or (4) an algorithm to evaluate the strength of sub-regions.

### 7. Identifying Skill Sets

Identifying preferred patterns in the data includes sorting the data into different neurological skill sets; and wherein said skill sets include but are not limited to: 16 or more cognitive skills, two values for hemispheric balance, use of five or more sensory modalities (auditory, kinesthetic, visual, meta, and executive), and four or more skill sets (directive skills, analytical skills, expressive skills, and reflective skills); and optionally said skills profile may include personality-related skills or psychological patterns.

### 8. Making the NeuroPQ Questionnaire

Preferrably developing a psychometric instrument for neurological skills assessment comprises: formulating questions for specific neurological skills, derived from known neocortex regions and their published scientific functions, and verification by psychological profiles derived from the ISCA (Nardi, most preferred), or MBTI or MPTI, or another equivalent psychometric instrument. See Table 1 for known functions of brain regions.

### 9. Content of the NeuroPQ Questions

The NeuroPQ instrument should assess at least five, and preferably ten, of the following propensities and abilities: (a) decisiveness, optimism and confidence; (b) ability to rationalize observations; (c) propensity to display emotion; (d) skill at leading others; (e) propensity to engage in introspection; (f) ability to think logically and deductively; (g) ability to rapidly create grammatically correct and efficient phrases; (h) skill at expressing humor and wit; (i) propensity to experience empathy for other people; (j) skill at memory recall; (k) skill at drawing images; and (l) skill at technically analyzing or playing music.

### 10. Content of the NeuroPQ Report

The instrument shall generate a report that evaluates an individual's answers to the instrument's questions. It shall include a neurological profile consisting of: at least 20 cognitive skills, two factors for hemispheric balance, at least five factors for sensory modalities, at least eight competency skills, and may include other neurological skills. It shall utilize a scoring system that rates each skill by a percentage (and optionally a color, shade or word label). Reports may include: diagrams, tables, logos, brain maps, chart points, icons, and other features.

### 11. Validating and Refining the Neuro-PQ

Preferrably the new “Neurological Performance Quotient” instrument is administered to subjects already tested by brain mapping and/or psychometric testing (ISCA, MBTI, MPTI or other instrument), to validate and refine the questionnaire's accuracy; and may be administered in multiple formats, including: a computer or online software version, or a paper and pencil version, or a card-sorting version, or an oral version, or other version.

### 12. Using the Neuro-PQ: Assessing Future Individuals

Preferrably the validated and refined “Neurological Performance Quotient” instrument can be administered to a future individual to generate a neurological skills profile, for the purpose of identifying strong and weak neurological skills, and which may be used in the fields of clinical counseling, business, or education, or other endeavors.

### 13. Clinical Applications

The Invention may be used for clinical applications, including evaluation and therapy, based on a person's psychological type/traits, cognitive skill levels, and associated psychological profile for a selected individual or group of individuals; wherein clinical evaluation of profiles may include styles of: attention, behavior, cognition, emotion, motivation, personality, and spirituality; and wherein clinical therapies may include: skills counseling, behavioral or emotional counseling, career counseling, cognitive development, couple's communication, family counseling, improvement of small group dynamics, and mind-body integration.

### 14. Business Applications

The Invention may be used for business applications, based on a person's psychological type/traits, cognitive skill levels, and associated psychological profile for a selected individual or group of individuals; wherein these may include: advertising and marketing, communication skills and team dynamics, consumer behavior, dating service compatibility, human-computer interaction, job placement, leadership and management, organizational development, political messaging, sales, skills development, social networking behavior, as well as media design for books, electronic pads or computer applications, film and television, magazines, questionnaires, and smart phones.

### 15. Educational Applications

The Invention may be used for educational applications, based on a person's psychological type/traits, cognitive skill levels, and any associated psychological profile, for a selected individual or group of individuals; wherein these may include: academic counseling, career counseling, media design for textbooks and electronic pad or computer applications, types of learners and learning modes such as sensory modalities (auditory, tactile, or visual), types of instructors and instructional methods and materials, academic strengths and weaknesses such as concrete verses abstract math learners.

### DETAILED DESCRIPTION OF THE INVENTION

### Example 1

### Methods

### Methods to Make the Invention

### Step 1: Gather Demographic Data

Administer consent forms and demographic forms for subjects to complete. Ideal subject is right-handed and free of brain damage, takes no mind-altering drugs, suffers no current mental impairments due to recent drug or alcohol use, sleeplessness, or mental illness, and has a history that is free of drug and alcohol abuse.

### Step 2: Administer Personality Assessments

Administer a personality-profiling tool and/or cognitive skills test such as Myers-Briggs Type Indicator. Store results for later scoring and analysis.

### Step 3: Administer EEG Session

Preparation:

Follow standard protocol for EEG preparation, calibration, and use. This study used a Mindset ms-1000 10/20 EEG machine with ECI brand Electro-Cap which records measurements for 16 (sixteen) neo-cortex regions. A similar 10/20 EEG model may also be used. Turn on automatic data recording. Ready lab notebook and related implements. The session should be held at a time of day that meets the subject's best energy level and held in a room with an outdoor view that is natural and non-distracting. During the session, administer a battery of tasks over a 2-3 hour period (ideally 45 minutes for each of 3 parts below, though up to 1 hour per part is okay if not desirable). After each task, debrief the subject by asking, “Please briefly describe your experience doing the task?” If that proves uninteresting, ask, “What did you see, hear, and/or feel during the task?” Ideally, the sum of tasks covers all cognitive skills associated with the neocortex.

### Part A:

Administer pre-defined solo tasks. These tasks should, as a whole, demand analytic and holistic thinking, engage the senses in both analytic and holistic ways, and involve opportunities for decision-making, interpretation, and problem solving. Ideally, the tasks are progressive or comparative in nature. E.g., subject solves a series of ever-harder math problems, signs name with both preferred hand and non-preferred hand, or plays a game at slow and fast pace.

### Part B:

Utilize confederates (lab assistants) to administer pre-defined social tasks. Tasks include games (e.g. card games), speed dating, group problem solving, creative construction (e.g. compose a story together given prompts), and role-play skits of familiar activities (e.g. e.g. confederate plays customer and subject plays employee). Include at least one task that requests reading someone else's emotions or intentions. When possible, entreat subject to stand during social exercises.

### Part C:

Ask subject to engage in tasks most relevant to the subject's area of creative expertise (e.g. playing musical instrument for musician, drawing a picture for an illustrator, solving math proofs for a mathematician, etc.) This may require tools such as a guitar or keyboard. Ideally, subject performs the activity 4 ways: simple performance, rehearsed difficult performance, imagined performed (eyes closed and visual in the mind), and improvisational performance.

These are essential tasks in order to complete step 7 below.
Sign name with preferred and non-preferred hand.
Listen activity to someone else.
Listen to music with eyes closed.
Review past experience and future situation, with eyes closed.
Toss a ball back and forth with confederate.
Make a decision and explain the decision afterward.
Engage subject to merely sit and wait for 3 minutes.

### Part D: Record Notable Observations

As the subject performs the tasks in step 3, maintain a logbook of the subject's actions and utterances and also notable events on the EEG, with time codes, for later reference. This is a qualitative recording. Be sure to note subject's EEG during the “must do” tasks above.

### Step 4: Calculate EEG Scores & PQs (Performance Quotients)

Review the EEG recording made during step 3 above. For each EEG region, calculate:

(a) Average amplitude for each region at each 1 minute interval.
(b) Average amplitude and related statistics (minimum, maximum, etc) over the whole session.
(c) Total representation of each frequency band (alpha, beta, delta, gamma, theta) for each region and for the entire neocortex over the whole session.
(d) Coherence events: For each region, how often it changes its frequency band with 1 or more other regions at the same time.
(e) Total number of coherence events for each region, and number of coherence events that are left and right hemisphere only versus cross-hemispheres.
(f) How many minutes each frequency band dominated over the other bands.

These results can be used in various ways. For example:

(g) Using information from (f) above, count the number of exceptional events in each region. A region's activity is notable when the dominant band is two or more bands higher than the average frequency band across the whole EEG at that time. Example: If region P3 is dominant beta (18.5-40 Hz) at time t and the average frequency of the rest of the neocortex is below 14.5 Hz (alpha 1 band or lower) at time t, then add +1 to the score for P3.
(h) Optionally, normalize the scores to an average for comparison against other subjects. For example, adjust all scores to average 10 or adjust all scores such that the highest equals 100. Represent the scores as normalized percentages, referred to here at “performance quotients” or PQs. The average of all scores equals 50%.

### Step 5: Create NeuroPQ Questionnaire

Analyze the results from steps 1 thorough 4 to create items that correspond to regions and/or subregions, and possibly their combinations. Include a response method and scoring system that yields results comparable to EEG results gained in step 4. Preferrably, have 60 items total with an equal number of items per region or subregion. Optionally, 1 item per region or subregion is acceptable (minimum 16 to 20). [See Example 2: Questionnaire.]

Preferrably, administer the NeuroPQ to subjects who complete steps 1 through 4 above until the instrument reaches an acceptable threshold of validity, such as linear correlation R-values of at least 0.5 when comparing personality types/traits in step 2 with PQs in step 4.

As a less preferred method, administer the NeuroPQ to subjects who complete steps 1 and 2 above, then group their results by personality type and compare the aggragate of results by personality type with the aggregate of results by personality type obtained for subjects who completed steps 1 through 4.

### Methods to Use the Invention

### Step 6: Administer NeuroPQ

Administer the NeuroPQ questionnaire in any one of multiple formats, including: a computer or online software version, or a paper and pencil version, or a card-sorting version, or an oral version, or other version.

Be sure subject reads instructions, which preferrably include the following. First, each description represents the contributions of a particular brain region, where all contributions are valuable. The subject reads and rates each description on a Likert (numeric) item scale, such as from 0 to 5, where 0 would least represent the subject's cognitive skills (such as “Rarely Use” or “Poorly Use”) and 5 would most represent his or her cognitive skills (such as “Often Use” or “Aptly Use”). The rating may be written, verbal, a button click, or other indication depending on the format. The subject utilizes the full spectrum of options. Results will be adjusted (normalized) against an average person. The subject can trust his or her “first impression”, and when identifying with some of aspects of a description but not others indicate a rating closer to the middle. Other instructions are possible depending on the questionnaire's format.

Depending on format, the NeuroPQ may include other elements. If the format includes elements that can be colored or shaded in, then the subject completes these visual elements. The format may ask the subject to calculate or be aware of subtotals of ratings. If the format includes sorting, such as into piles or bins, then the subject sorts. For example, the subject might sort cards into six color-coded piles, ending up with an equal number of cards in each pile, where the piles equivacate to a Likert item scale. If format permits, the subject can total the ratings or be presented with a ratings total to review in order to re-rate some items and recalculate a total closer to an average. For example, for 60 items rated on a scale of from 0 to 5, a perfectly average total score equals 150 (60×2.5=150). If the subject's ratings total 165, then the subject may revise responses to move the total down toward 150.

Alternate Instructions #1: A so-called “three-sixty” method, where multiple subjects (colleagues, family members, etc) rate each other in addition to themselves. Instructions are the same as above for each use except the person answers with someone else in mind.

Alternate Instructions #2: A negotiated rating system, where two or more subjects who are familiar with each other interact question-by-question to jointly decide ratings for each other.

Alternate Instructions #3: Subject completes one or more tasks for each portion of the questionnaire. Then, the subject's performances on tasks are graded to equivicate to a Likert item scale. For example, subject tries an analogy completion task. Grade the task for correct completions and convert the grade to a Likert scale, where poor performance matches to the low end of the scale and good performance matches to the high end of the scale.

### Step 7: Calculate Cognitive Scores & PQs (Performance Quotients)

For each NeuroPQ brain region (1 to 20), calculate a score, which equals the total of all items representing that region. Next, sum all scores to learn the total of the entire questionnaire.

Preferrably, normalize the total and scores for a fair comparison against other subjects. For example, given 60 items on a scale of 0 to 5, the average score equals 150. If the subject's total score equals 165, then reduce all scores such that the average becomes 150 while the range for each region remains greater than or equal to 0 and less than or equal to the maximum total possible without normalizing. Finally, represent the scores as normalized percentages, referred to here at “performance quotients” or PQs. The average of all scores equals 50%. A less preferred method is to not normalize scores.

Optional Calculation: Calculate an average score for each region for use in other steps. First, calculate an average score for each region. Example, given three scores of 2, 3, and 5, the average is 3.3. Regarding rounding to an integer, the preferred method is to round toward a mid-point. For example, using a Likert item scale of 0 to 5 where 2.5 is average, 3.3 and 3.6 both round down to 3 while 1.3 and 1.6 both round up to 2.

### Step 8: Prepare a Shaded or Colored Map

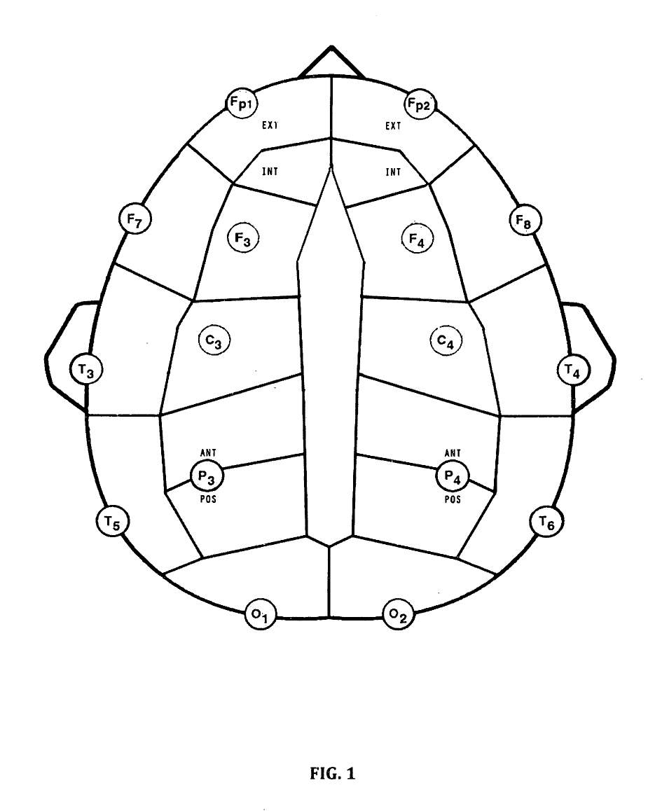

Use the PQ results in Example 7 above to prepare a colored or gray-scale illustration of the subject's neocortex. Start with a labeled bird's eye view of the neocortex as typically used during EEG research. See FIG. 1. Refer to the following legend:

TABLE 2
EEG Map Legend

| TIER | COLOR* | SHADE | PQ |
|---|---|---|---|
| Very high | Red | White | 83% < x < 100% |
| High | Orange | Light gray | 66% < x < 84% |
| Medium-High | Yellow | Medium light gray | 49% < x > 67% |
| Medium-Low | Green | Medium dark gray | 33% < x < 50% |
| Low | Blue | Dark gray | 16% < x <34% |
| Very Low | Black | Black | x < 17% |

• Use of color here indicates EEG amplitude (not frequency).

### Step 9: Calculate Hemispheric Usage

Calculate contribution of left hemisphere regions versus right hemisphere regions of the neocortex according to the PQ scores gained in step 4.

Left hemisphere=(Fp1−ext.+Fp1−int.+F3+F7+C3+T3+T5+P3−ant.+P3−pos.+O1)/10

Right hemisphere=(Fp2−ext.+Fp2−int.+F4+F8+C4+T4+T6+P4−ant.+P4−pos.+O2)/10

### Step 10: Calculate Sensory Modalities

Calculate use of regions involved in sensory modalities. The categories of auditory, kinethetic/tactile, visual, and executive are basic neuro-physiology. The meta category includes all other regions not included in those categories.

TABLE 3
Calculating Sensory Modalities

| | CALCULATION | |
|---|---|---|
| CATEGORY | METHOD | DESCRIPTION |
| Auditory | (T3 + T4 + F3 + F4)/4 | Listening, speaking, |
| | | music, metaphor, voice tone |
| Kinesthetic/ | (C3 + C4 + P3-ant. + | Moving, touching, |
| Tactile | P4-ant.)/4 | sensation, space & |
| | | boundaries |
| Visual | (O1 + O2 + P3-pos. + | Seeing, imagery, |
| | P4-pos.)/4 | identifying images, |
| | | visualizing |
| Meta | (F7 + F8 + T5 + T6)/4 | Social, cultural, values, |
| | | identity, timelines |
| Executive | (Fp1-ext. + Fp2-ext. + | Prioritizing other |
| | Fp1-int. + Fp2-int.)/4 | modalities, deciding, |
| | | explaining, self-reflecting, |
| | | facilitating |

### Step 11: Calculate Competency Skill Sets

Calculate use of regions organized in various ways such as skill sets:

TABLE 4
Calculating Skill Sets

| | METHOD OF | DESCRIPTION OF |
|---|---|---|
| SKILL SET | CALCULATION | COMPETENCIES |
| Directive | Fp1-ext. + P3-ant. + | Make decisions, follow steps |
| Skills | C3 + T5 + F8 | to goals, respond to relevant |
| | | feedback, confirm norms, and |
| | | stick to beliefs. Confident, |
| | | normative, and maybe controling. |
| Analytical | Fp1-int. + P3-pos. + | Explain, attend to word content, |
| Skills | F3 + T3 + O1 | note and fix errors, chart action |
| | | steps, and stick to visible data. |
| | | Self-controlled, precise, and |
| | | maybe anxious. |
| Expressive | Fp2-ext. + P4-ant. + | Elicit new input, engage exciting |
| Skills | F4 + T4 + F7 | stimuli, use concepts and analogies, |
| | | attend to voice tone, and build |
| | | rapport. Enthusistic, persuasive, |
| | | and maybe scattered. |
| Reflective | Fp2-int. + P4-pos. + | Explore new data, compose |
| Skills | C4 + T6 + O2 | artistically, attend to symbols |
| | | and impressions, weigh many |
| | | factors at once. Quietly receptive, |
| | | patient, and maybe passive. |

### Step 12: Infer Likely Alternate Psychometric Result

One can infer the results of another psychometric instrument such as MBTI 4-letter type code so long as it was used as part of validating the NeuroPQ. Refer to the subject's results from steps 4 through 7 above and match them against a database of psychometric results or a list of rules to locate best matches.

For example, infer a person's Myers-Briggs type code by comparing the person's NeuroPQ scores, and results derived from the analysis of their scores, to a database of NeuroPQ results of persons of known personality type. Display the percent match of NeuroPQ results with each entry in the database as well as the best matches (or two or three best matches) that are likely type codes. Alternatively, to locate a Myers-Briggs type code, you can refer to a list of if-then rules and/or other criteria that determine the subject's best fitting type codes.

### Step 13: Compare to Other Results

Compare the subject's results gained in steps 7 through 11 against the results of other persons, agregates of persons, or hypothetical agregates desirable for a career, group, job, task, or other context for an individual, group, or organizational report. If the subject has multiple NeuroPQ results over time, compare earlier and later results. You may visualize comparisons side-by-side or on a matrix or by any other means. You can use the results with other results to calculate statistics such as an average score.

### Step 14: Suggest Recommendations

Determine the subject's primary context/s of need, whether business, clinical, or education. Refer to steps 7 through 12 above to locate psychological strengths and limitations. Client should utilize strengths and may wish to address limitations.

### Detailed Description of the Invention

### Example 3

### Results

### Case History

### Part 1: Demographic Data

### Name: “Joe Smith”

### Handedness: Right

### Sex: Male

### Age: 22

### Part 2: Psychometric Data (Optional)

Add the psychological type code from subject's psychometric test results from the Myers-Briggs Typing system or an equivalent system.

### Myers-Briggs Type Code: INFJ

### Part 3: Scores for Cognitive Skills and PQ

TABLE 5
Subject 1's EEG Scores for Cognitive Skills and PQ*

| REGION | SCORE | PQ* |
|---|---|---|
| Fp1-ext. | 9/15 | 57% |
| Fp1-int. | 10/15 | 63% |
| F7 | 11/15 | 70% |
| F3 | 5/15 | 30% |
| T3 | 12/15 | 77% |
| T5 | 6/15 | 37% |
| C3 | 3/15 | 17% |
| P3-ant. | 8/20 | 37% |
| P3-pos. | 8/15 | 50% |
| O1 | 3/10 | 27% |
| Fp2-ext. | 5/ 15 | 30% |
| Fp2-int. | 11/15 | 70% |
| F8 | 9/15 | 57% |
| F4 | 7/15 | 43% |
| T4 | 13/15 | 83% |
| T6 | 14/15 | 89% |
| C4 | 5/15 | 30% |
| P4-ant. | 8/20 | 37% |
| P4-pos. | 10/15 | 63% |
| O2 | 4/10 | 37% |

** Percentages are normalized and may not average exactly 50% due to mathematical rounding.

### Part 4: Make A Shaded/Colored Map

Make a colored or shaded map of the neocortex area based on EEG recordings. Subject 1's Neocortex map will look like the drawing of FIG. 1, but be colored or shaded to reflect the subject's individual EEG patterns. See color and shading Map Legend in Table 6 below.

TABLE 6
Subject 1's EEG Map Legend

| | | | | SUBJECT'S |
|---|---|---|---|---|
| TIER | COLOR | SHADE | PQ | REGIONS |
| Very high | Red | White | 83% < x < 100% | T4 |
| High | Orange | Light gray | 66% < x < 84% | Fp2-int., T3, F7 |
| Med-High | Yellow | Med light | 49% < x > 67% | Fp1-ext., Fp1-int., |
| | | gray | | F7, P3-pos., F8, |
| | | | | P4-pos. |
| Med-Low | Green | Med dark | 33% < x < 50% | T5, P3-ant., T6, |
| | | gray | | P4-ant., O2 |
| Low | Blue | Dark gray | 16% < x < 34% | Fp2-ext., F3, C3, |
| | | | | C4, O1 |
| Very Low | Black | Black | x < 17% | None |

### Part 5: Hemispheric Balance

TABLE 7
Subject 1's Hemispheric Usage (Right Brain Vs Left Brain)

| HEMISPHERIC | | |
|---|---|---|
| BALANCE | PQ* | STYLE |
| Left Hemisphere | 46% | Analytical, focused, context-specific style. |
| Right Hemisphere | 54% | Holistic, diffuse, global style. |

*Percentages are normalized and may not average exactly 50% due to mathematical rounding.

### Part 6: Sensory Modalities

TABLE 8
Subject 1's Sensory Modality Usage

| Category | PQ* | SENSORY MODALITIES |
|---|---|---|
| Auditory | 58% | Listening, Speaking, music, metaphor, voice tone. |
| Kinesthetic | 30% | Moving, touching, sensation, space & boundaries. |
| Visual | 46% | Seeing, imagery, identifying images, visualizing. |
| Meta | 63% | Social, cultural, values, identity, timelines. |
| Executive | 54% | Prioritizing other modalities, making decisions. |

*Percentages are normalized and may not average exactly 50% due to mathematical rounding.

### Part 7: Competency Skill Sets

TABLE 9
Subject 1's Skill Sets

| SKILL SET | PQ* | DESCRIPTION OF COMPETENCIES |
|---|---|---|
| Directive | 40% | Make decisions, follow steps to goals, |
| Skills | | respond to relevant feedback, confirm |
| | | norms, and stick to beliefs. Confident, |
| | | normative, and maybe controling. |
| Analytical | 50% | Explain, attend to word content, note |
| Skills | | and fix errors, chart action steps, and |
| | | stick to visible data. Self-controlled, |
| | | precise, and maybe anxious. |
| Expressive | 51% | Elicit new input, engage exciting stimuli, |
| Skills | | use concepts and analogies, attend to voice |
| | | tone, and build rapport. Enthusistic, |
| | | persuasive, and maybe scattered. |
| Reflective | 59% | Explore new data, compose artistically, |
| Skills | | attend to symbols and impressions, weigh |
| | | many factors at once. Quietly receptive, |
| | | patient, and maybe passive. |

*Percentages are normalized and may not average exactly 50% due to mathematical rounding.

### Part 8: Alternate Psychometric Results (Optional)

### Best-fit Type Code: INFJ

### Alternate Type Codes: INFP, INTJ

### Part 9: Recommendations

### (a) Strengths:

Most-Active Regions: T6, T4, Fp2−int., T3, and F7.

Cognitive Skills: Attends to voice tone, intentions, and ethics. Also, attends to word choice and usage. Displays rich imagination, skill with analogies and inferences, and mirrors others to learn or experience empathy. Attends to symbols, visual patterns, and faces. Finally, leads with an open-ended responsive style that emphasizes self-reflection and managing processes.

Competencies: Introverted Leadership, Envisioning the Future, Listening and Speaking, Social/Cultural.

### (b) Limitations:

Least-Active Regions: Fp2−ext., F3, C3, C4, and O1.

Cognitive Limits: Weak at logical deduction, and challenged to read without bias or inference. Poor motor control, does not attend to follow physical steps or routine, poor at visual tasks such as rotating mental objects, and does not trust visual data. Finally, not adept as an open-ended initiating leader that leads by enthusiasm or pursuit of novely.

Limitations: Extroverted Leadership, Logical, Vision, Body and Sensation.

### (c) Suggestions:

Business: Subject is best suited to job positions that involve interaction with others, but in a responsive role, such as counseling or customer service. Subject is least suited to jobs that involve motor skills, visual acuity, and logic, particularly in an extroverted role, such as engineer or machine operations manager.

Counseling: Subject has social/cultural skills, focuses on listening for ethics, and is self-reflective and attentive to process. Subject may have high self-awareness and hold to high standards for relationships. Subject may at times be unaware of a partner's nonverbal feedback and likely has low body awareness. Subject is likely unconvinced by logic and reason.

Education: Subject is an auditory learner. Subject is best suited to humanities and social sciences. Subject is least suited to athletics/outdoors and math/engineering.

### Patentability

This invention meets the criteria for patentability, as it is a useful, novel, and unobvious process. It employs a method of physically mapping brain waves, and using the known functions of brain regions, with verification from a psychometric instrument, to determine neurological and cognitive skills for individuals. It is an unobvious invention to psychologists or social workers, who traditionally use questionnaires or observation, and have little or no training in electronic evaluation. It is useful to assist clients to determine their innate skills, and has commercial value for counseling, business, and education. It also provides multiple use categories, such as: 2 values for hemispheric balance, use of five or more sensory modalities (auditory, kinesthetic, visual, meta, and executive), and four or more skill sets (directive skills, analytical skills, expressive skills, and reflective skills); and optionally said profile may include other skills.

The details of the final invention are a trade secret, and have not been known or used by others. No scientific, commercial, or popular papers have been published containing the final research. No commercial products or sales have been made containing the details as described herein until recently by the Inventor. A U.S. Provisional Patent Application No. 61/682,242 titled Nardi Neurotype System & Neurological Performance Quotient, filed Aug. 10, 2012, and no patents have been applied for elsewhere. Presentations have been made since that time.

### CONCLUSIONS, RAMIFICATIONS, AND SCOPE

Accordingly, the Neurological Performance Quotient invention provides a novel psychometric instrument for assessing neurological skill sets for individuals, derived from brain-mapping and testing for cognitive types. The advantages are multiple:
(1) The Invention is more accurate because it employs objective brain mapping as its basis.
(2) The functions of each brain region are based on published scientific research.
(3) The Invention is verified by highly vetted psychometric instruments (MBTI™ or ISCA).
(4) The Invention identifies multiple neurological skills by means not previously available.
(5) The Invention measures and ranks twenty innate cognitive skills.
(6) The Invention measures and ranks hemispheric balance (right brain vs left brain).
(7) The Invention measures and ranks five sensory modalities.
(8) The invention measures and ranks four skill sets (directive/protective skills, analytical skills, expressive skills, and reflective skills).
(9) The NeuroPQ instrument is faster, cheaper, and easier to administer than brain mapping.
(10) The NeuroPQ instrument can be administered to millions of people in multiple formats, including: online, as a computer program, a written questionnaire, on cards, or orally.

Although the description above contains many specificities, these should not be construed as limiting the scope of the invention, but as merely providing examples of the presently preferred embodiments of this invention. It could include other embodiments. Thus the scope of the invention should be determined by the appended claims and their legal equivalents, rather than by the examples given.

1. A method of formulating a novel psychometric instrument (scorable questionnaire), based on data from brain mapping, for the purpose of generating a neurological skills profile for an individual, comprising the following steps:
(a) Conducting brain wave mapping on human subjects to identify the levels of intensity of specific brain wave patterns in and across regions with known functions, while administering tasks related to specific brain regions;
(b) Researching and developing a table of neurological functions for specific regions of the brain neocortex, and linking said functions with the brain mapping data from step (a),
(c) Assessing cognitive skill levels and/or psychological traits/types of each subject;
(d) Verifying the brain mapping data (step a) and related functions (step b) with a psychometric assessment from step (c), using appropriate statistical methods to develop and/or verify data;
(e) Identifying patterns in the data (step d) to group data into different neurological skill sets;
(f) Developing questions for specific neurological skills, based on the data (step d), for the purpose of formulating a psychometric instrument for neurological skills;
(g) Devising a report containing an evaluation and scoring system for the instrument;
(h) Optionally, administering the instrument to subjects tested in step (a) and step (c) to validate and refine questionnaire accuracy;
(i) Administering the refined instrument to a future individual to generate a neurological skills profile.

2. A method according to claim 1, wherein said “brain mapping” is conducted by electro-encephalographic (EEG) brain wave mapping on human subjects, or a comparable device, wearing a wired cap connected to a stationary monitor, for measuring and recording the electrical intensity of specific neocortical regions, each having a designated code and known function, and identifying specific brain wave patterns, which manifest in or across specific neocortical regions, in response to a variety of questions and stimuli administered by a researcher or psychotherapist, over a two to three hour period.

3. An alternate method according to claim 2, wherein said brain wave mapping is conducted on a subject who is fitted with a wireless EEG headset that connects to a wearable or stationary monitor, for measuring and recording electrical intensity of specific neocortical regions, each having a designated code and known function, and wherein brain wave patterns, which manifest in or across specific neocortical regions, are generated in response to ordinary daily activity that is recorded in an activity log, and is periodically monitored by a researcher or psychotherapist.

4. A method according to claim 1, of researching and developing a table of neurological functions or skills for specific regions (or set of regions) of the brain neocortex, and linking said functions with the brain wave mapping data; and wherein each region is designated by a code name, a skill set, and a brief profile defining psychological and neurological functions, as shown in Table 1 of the Description, entitled “Twenty Neocortex Regions and Their known Functions.”

5. A method according to claim 1, wherein said psychometric instrument (scorable questionnaire), may be selected from the group consisting of: (a) the ISCA (Interstrength Cognitive Assessment by Dario Nardi, that determines eight cognitive types and profiles; (b) the MBTI (Myers-Briggs Type Indicator Instrument) that determines sixteen personality types and profiles; (c) the MPTI (Majors Personality Type Indicator) that determines sixteen personality types and profiles; and/or (d) any other equivalent psychometric instrument.

6. A method according to claim 1, wherein statistical methods include the two commonly accepted methods for EEG research: (a) qualitative analysis, consisting of observations recorded in a lab book and/or on video of recorded brain activity and behavior patterns; and (b) quantitative analysis, consisting of algorithms and factor analysis based on recorded EEG session data; and wherein factors for analysis include the anatomical brain region codes (16 or more codes); and factors for verification may include: published scientific research, the eight cognitive function designations (ISCA, Nardi), the sixteen personality designations (MBTI or MPTI), or another equivalent psychometric instrument; optionally, data may be analyzed to determine sub-regions of brain activity based on (1) linkages between two or more brain regions; (2) regions that often activate simultaneously; (3) a nullifying effect, and/or (4) an algorithm to evaluate the strength of sub-regions.

7. A method according to claim 1, wherein identifying patterns in the data includes sorting the data into different neurological skill sets; and wherein said skill sets include but are not limited to: 16 or more cognitive skills, two values for hemispheric balance, use of five or more sensory modalities (auditory, kinesthetic, visual, meta, and executive), and four or more skill sets (directive skills, analytical skills, expressive skills, and reflective skills); and optionally said skills profile may include personality-related skills or psychological patterns.

8. A method according to claim 1, wherein developing a psychometric instrument for neurological skills comprises: formulating a questionnaire with corresponding questions for each neurological skill, derived from a specific neocortex region and its published scientific functions, and verified by psychological profiles derived from the ISCA (Nardi) or MBTI or MPTI or equivalent psychometric instruments.

9. A method according to claim 8, wherein the psychometric instrument assesses at least five, and preferably ten, of the following propensities and abilities: (a) decisiveness, optimism and confidence; (b) ability to rationalize observations; (c) propensity to display emotion; (d) skill at leading others; (e) propensity to engage in introspection; (f) ability to think logically and deductively; (g) ability to rapidly create grammatically correct and efficient phrases; (h) skill at expressing humor and wit; (i) propensity to experience empathy for other people; (j) skill at memory recall; (k) skill at drawing images; (l) skill at technically analyzing or playing music.

10. A method according to claim 1, wherein the psychometric instrument generates a report that evaluates an individual's answers to the instrument's questions, which includes a neurological profile consisting of: at least 20 cognitive skills, two factors for hemispheric balance, at least five factors for sensory modalities, at least eight competency skills, and may include other neurological skills; and it shall utilize a scoring system that rates each skill by a percentage (and optionally a color or shade); and it may include: diagrams, tables, logos, brain maps, chart points, icons, and other features.

11. A method according to claim 1, wherein optionally, the neurological skills instrument is administered to subjects already tested by brain mapping and/or psychometric testing (ISCA, MBTI, MPTI or other instrument), to validate and refine the questionnaire's accuracy; and may be administered in multiple formats, including: a computer or online software version, or a paper and pencil version, or a card-sorting version, or an oral version, or other version.

12. A method according to claim 1, wherein the validated and refined neurological skills instrument can be administered to a future individual to generate a neurological skills profile, for the purpose of identifying strong and weak neurological skills, and which may be used in the fields of clinical counseling, business, education, or other endeavors.

13. The method of claim 12 further comprising clinical applications, including evaluation and therapy, based on a person's psychological type/traits, cognitive skill levels, and associated psychological profile for a selected individual or group of individuals; wherein clinical evaluation of profiles may include styles of: attention, behavior, cognition, emotion, motivation, personality, and spirituality; and wherein clinical therapies may include: skill sets, behavioral or emotional counseling, career counseling, cognitive development, couple's communication, family counseling, improvement of small group dynamics, and mind-body integration.

14. The method of claim 12 further comprising business applications, based on a person's psychological type/traits, cognitive skill levels, and associated psychological profile for a selected individual or group of individuals; wherein these may include: advertising and marketing, communication skills and team dynamics, consumer behavior, dating service compatibility, human-computer interaction, job placement, leadership and management, organizational development, political messaging, sales, skills development, social networking behavior, as well as media design for books, electronic pads or computer applications, film and television, magazines, questionnaires, and smart phones.

15. The method of claim 12 further comprising educational applications, based on a person's psychological type/traits, cognitive skill levels, and associated psychological profile, for a selected individual or group of individuals; wherein these may include: academic counseling, career counseling, media design for textbooks and electronic pad or computer applications, types of learners and learning modes such as sensory modalities (auditory, tactile, or visual), types of instructors and instructional methods and materials, academic strengths and weaknesses such as concrete verses abstract math learners.
